(19) United States
(12) Patent Application Publication
(10) Pub. No.: US 2008/0187168 A1
(43) Pub. Date: Aug. 7, 2008

(54) Driver for a speaker

(75) Inventor: Vu-Quang Dam, Chiayi City (TW)

Correspondence Address: BACON & THOMAS, PLLC, 625 SLATERS LANE, FOURTH FLOOR, ALEXANDRIA, VA, 22314, US

(73) Assignee: DK SIGNAL LTD., CHIAYI CITY (TW)

(21) Appl. No.: 11/797,786

(22) Filed: May 8, 2007

(30) Foreign Application Priority Data
Feb. 6, 2007 (TW) 96202275

(51) Int. Cl. H04R 11/02; H04R 1/00

(52) U.S. Cl. 381/420

(57) ABSTRACT

A driver for a speaker including: an upper housing, a lower housing and a vibration device, wherein said upper housing combines with said lower housing to form a chamber therein. The vibration device is received in the chamber. The vibration device is basically constituted with an acoustic phase equalizer, a diaphragm, a flux guiding plate, a magnet and a yoke. By the design of present invention, the disadvantage of poor radiation efficiency in prior art can be improved and extends the operation period.

### BACKGROUND OF THE INVENTION

1. Field of the Invention

The present invention relates to a speaker, more particularly to a driver for driving a speaker.

2. Description of the Related Art

A permanent magnet and a diaphragm with a coil are used as a driver for speaker in prior art usually. By the magnetism that generates by the electrified coil is the same as or the different from the magnetism of the permanent magnet, the repulsion or the attraction will cause the diaphragm to vibrate and generates a sound.

The structures of the driver that has a rare earth magnet therein use the rare earth magnet to replace the permanent magnet and reduce the chamber as disclosed in Taiwan Patent 375346. Even though the change shrinks the chamber but still generates the same heat. Because of the heat transmits by air in this prior art patent, the radiation efficiency is poor. The heat cannot transmit through out the shell efficiently. So, the temperature in the driver for a speaker will rise and cause the diaphragm to deform in the high-temperature environment for a long period and shorten the operation period of the driver for a speaker.

As aforesaid, there is a disadvantage that needs to improve in the speaker of the prior art.

### SUMMARY OF THE INVENTION

The object of the present invention is to provide a driver for a speaker, which can increase the radiation efficiency of the driver for a speaker and operation period also.

To achieve this object of the present invention, the driver for speaker of present invention including: an upper housing, a lower housing and a vibration device. The vibration device is received in the chamber. The vibration device is basically constituted with an acoustic phase equalizer, a diaphragm, a flux guiding plate, a magnet and a yoke in order. The yoke lodges in the lower housing tightly and the gap is filled up with thermal grease. By the way, present invention can improve the radiation efficiency and protects the diaphragm and increases the operation period by the design of the structures as aforesaid.

### BRIEF DESCRIPTION OF THE DRAWINGS

FIG. 1 is an exploded view of the present invention;

FIG. 2 is a combination view of the present invention, which is showing the combination status of every parts of the driver for speaker;

FIG. 3 is a combination view of the present invention, which is showing the combination status of every parts of the driver for speaker, and the gap is filled up with thermal grease.

### DETAILED DESCRIPTION OF THE INVENTION

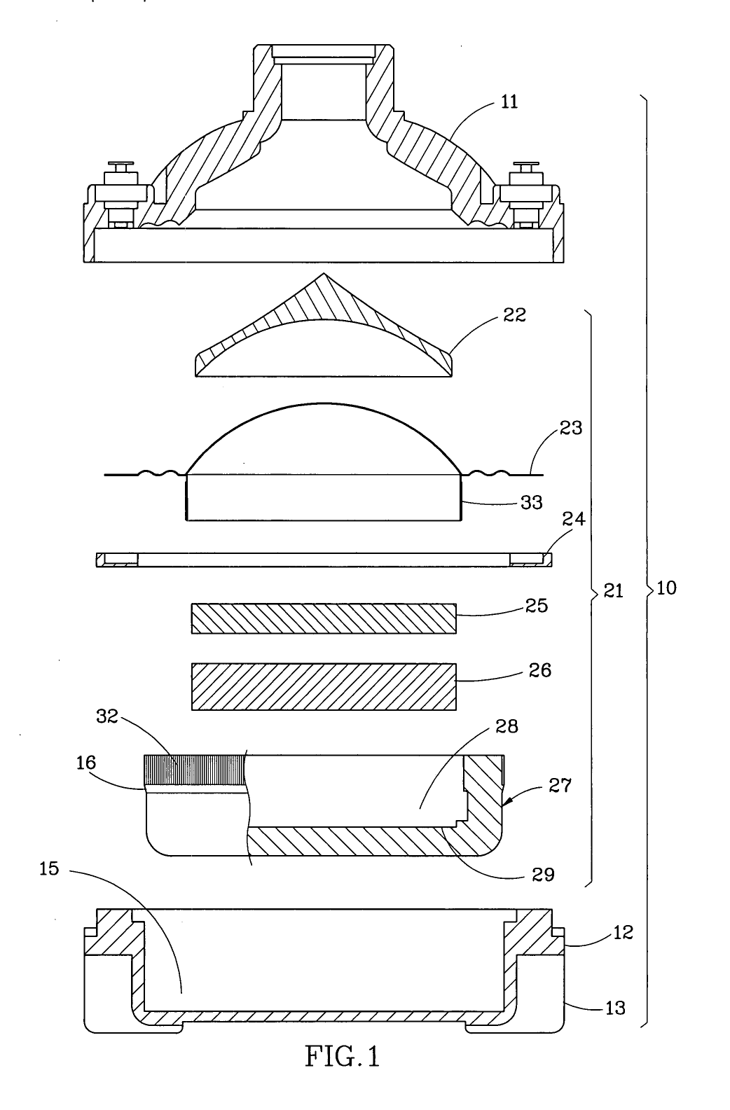

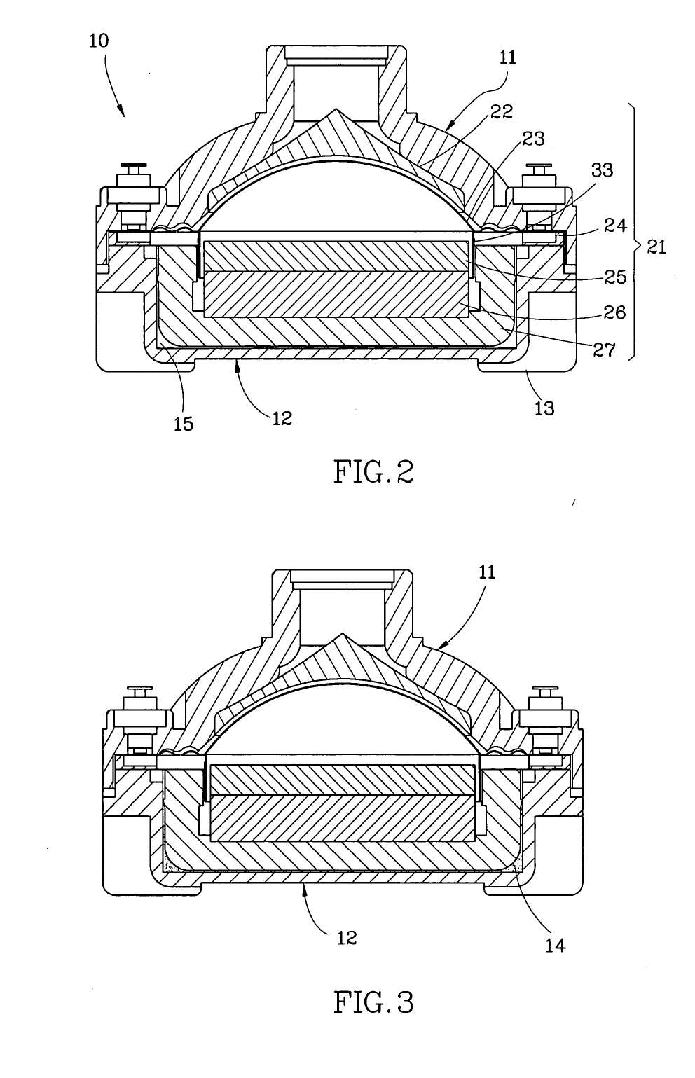

Referring to FIG. 1 to 2, the driver for speaker of present invention including: an upper housing 11, a lower housing 12 and a vibration device 21.

There is a plurality of dissipating fins 13 provided on the outside surface of said lower housing 12.

Said lower housing 12 has a cavity. Said upper housing 11 combines with said lower housing 12 to from a chamber 15 therein.

Said vibration device 21 is received in said chamber 15. Said vibration device 21 is constituted with an acoustic phase equalizer 22, a diaphragm 23, an annular flange 24, a flux guiding plate 25, a magnet 26 and a yoke 27 basically.

Said yoke 27 provides a recess 28 from top to bottom. Said magnet 26 and said flux guiding plate 25 are placed in said recess 28. There is a predetermined distance between the edge of said magnet 26 and the inner surrounding wall of said recess 28, and there is a predetermined distance between the edge said flux guiding plate 25 and the inner surrounding wall of said recess 28 also. The bottom of said recess 28 provides a fixed pit 29. The shape of said fixed pit 29 limits the bottom side of said magnet 26 and make said magnet 26 to stay at the center of said recess 28. A flange 32 extrudes from the topside of said yoke 27. There is a plurality of vertical ribs provided on the outside surface of said flange 32. An incline 16 is provided downward and inward along with the bottom of said flange 32 on the outside wall of said yoke 27. Said yoke 27 can join with said lower housing 12 tight by the outside wall of said flange 32.

An annular extension 33 sets up on the bottom of said diaphragm 23. Said annular extension 33 covers on the outside wall of said flux guiding plate 25 and makes said annular extension 33 placed between the inside wall of said yoke 27 and the outside wall of said flux guiding plate 25. Said annular extension 33 has a voice coil therein.

When the driver for speaker is fabricated, the bottom side of said upper housing 11 connects with said acoustic phase equalizer 22. Said diaphragm 23 adjoins said acoustic phase equalizer 22. A fixed annular 24 is installed on the outside flange of said diaphragm 23 for fixing said upper housing 11, said diaphragm 23 and said lower housing 12 together. Said diaphragm 23 covers on said flux guiding plate 25 and said magnet 26 by said annular extension 33, which is inside said yoke 27. Said yoke 27 just lodges in said lower housing 12. The flange 32 of said yoke 27 sags a little bit and makes the outer wall surface of said yoke 27 connects with the inner wall surface of said lower housing 12 tightly. The outer wall surface of said yoke 27 partially connects to the inner wall surface of said lower housing 12 at least. The gap that is formed between the downside outer wall surface of said yoke 27 and the inner wall surface of said lower housing 12 is filled up with thermal grease 14 and no space will be left.

The electrified annular extension 33 will generate a magnetic force. The magnetic force will attract or repulse the magnetism of said magnet 26 and cut across the magnetic field, and causes said diaphragm 23 to vibrate and generates a sound. The driver for speaker reaches the object of driving a speaker. When the magnetic force cuts across the magnetic field, said magnet 26, said flux guiding plate 25 and said yoke 27 will generate heat. Due to said yoke 27 partially connects with said lower housing 12 and the gap is filled up with thermal grease 14, the heat can transmit to said lower housing 12 or passes by the thermal grease 14 to said lower housing 12 quickly. By the conduction of said dissipating fins 13, the heat will not stay in said chamber 15 and dissipates quickly. The good radiation efficiency will be reached and the magnet 26 can be kept the inside of the driver for a speaker 10 in normal operation temperature.

As aforesaid, the driver for speaker of present invention can really reduce the operation temperature of the driver for speaker and protects the diaphragm 23, and increases the operation period. So, present invention can erase the inconvenience and persecution in operation of prior art. Depending on the patent law, the applicant files the application.

Those structures of present invention as aforesaid are only for illustration and not for limiting the scope of claims. It should be take as in the scope of present invention by every equivalent replacement.

What is claimed is:

1. A driver for speaker, including:
an upper housing and a lower housing, said upper housing combining with said lower housing to form a chamber therein;
a vibration device being placed in said chamber and said vibration device being constituted with an acoustic phase equalizer, a diaphragm, a flux guiding plate, a magnet and a yoke; said yoke provides a recess from top to bottom and said magnet and said flux guiding plate are placed in said recess in order; a flange extruding from the topside of said yoke with predetermined thickness; the downside shape of the outer wall surface of said yoke matching with portion of the inner wall surface of said lower housing; said yoke lodging in said lower housing and the outer wall surface of said yoke staying partially connected to the inner wall surface of said lower housing.

2. The driver as claimed in claim 1, wherein there is a predetermined distance between the edges of said magnet and the inner surrounding wall of said recess, and there is a predetermined distance between the edge of said flux guiding plate and the inner surrounding wall of said recess also.

3. The driver as claimed in claim 1, wherein the bottom of said recess provides a fixed pit and the shape of said fixed pit limits the bottom side of said magnet and make said magnet to stay at the center of said recess.

4. The driver as claimed in claim 1, wherein an incline is provided from top to bottom and from outside to inside along with the bottom of said flange on the outside wall of said yoke.

5. The driver as claimed in claim 1, wherein an annular extension sets up on the bottom rim of said diaphragm; said annular extension that has a voice coil therein covers on the magnet and is placed between the inside wall of said yoke and the outside wall of said flux guiding plate.

6. The driver as claimed in claim 1, wherein there is a plurality of dissipating fins provided on the out side of said lower housing.

7. The driver as claimed in claim 1, wherein portion of the downside outer wall surface of said yoke partially connected to the inner wall surface of said lower housing at least.

8. The driver as claimed in claim 1, wherein the gap between said yoke and said lower housing is filled up with thermal grease.
